(19) United States
(12) Patent Application Publication
(10) Pub. No.: US 2025/0380730 A1
(43) Pub. Date: Dec. 18, 2025

(54) PLANT ONLY UMAMI FLAVORING REPLACEMENT SYSTEM IN FOOD PRODUCTS

(71) Applicant: The Live Green Group, Inc.,, Middletown, DE (US)

(72) Inventors: Sasikanth Chemalamudi, San Fernando (CL); Priyanka Srinivas, San Fernando (CL)

(21) Appl. No.: 18/879,270

(22) PCT Filed: Jul. 7, 2023
(86) PCT No.: PCT/IB2023/057025

§ 371 Date: Dec. 27, 2024

Related U.S. Application Data
(60) Provisional application No. 63/358,923, filed on Jul. 7, 2022.

(51) Int. Cl. A23L 27/12; A23L 27/10; A23L 27/14; A23L 31/00

(52) U.S. Cl. CPC A23L 27/12; A23L 27/105; A23L 27/13; A23L 27/14; A23L 31/00

(57) ABSTRACT

A plant only umami flavoring replacement system in food products is provided. The plant-only umami flavoring replacement system in food products is prepared by mixing a) 5-15% by weight of a fruit source, b) 10-35% by weight of a fungal source, c) 5-15% by weight of a vegetable source, d) 5-10% by weight of an aquatic plant source, e) 5-15% by weight of a bulb source and f) 5-10% by weight of spice and herb plant source. The plant-only ingredients for umami flavoring replacement system effectively added for various dishes, including soups, sauces, marinades, meats, vegetables, and snacks to enhance the flavoring.

### CROSS-REFERENCE TO RELATED APPLICATIONS

This application claims priority to the U.S. provisional patent application No. 63/358,923, filed on Jul. 7, 2022 and PCT provisional patent application no.: PCT/IB2023/057025, filed on Jul. 7, 2023, titled “PLANT ONLY UMAMI FLAVORING REPLACEMENT SYSTEM IN FOOD PRODUCTS” and is incorporated herein by reference.

### TECHNICAL FIELD

The disclosed embodiment relates to the general food compositions and more particularly, plant-only umami flavoring replacement system in food products. More particularly, umami is a category of taste in food (besides sweet, sour, salt, and bitter), corresponding to the flavour of glutamates, especially monosodium glutamate.

### BACKGROUND OF THE DISCLOSED EMBODIMENT

The categories of commercially available food products containing such additives vary greatly, and include animal flesh-based (i.e., any one or more of beef, pork, poultry, fish, shellfish) and other seafood and other products with an umami-flavor, including imitation meat/seafood-containing products (i.e., meat or seafood analogs) in various forms based whole or in part on plant-derived materials, or food products composed of a combination both animal-source and plant-sourced materials.

As an example, these food products may be traditional meat-based products, as well as commercially available Meat/Seafood such as imitation meat/Crab products such as “imitation” crab (which may contain fish and other fish products), etc., as well as plant-based or “plant-only” Meat/Seafood alternatives (analogs).

Traditional, meat-based or seafood-based food products—which may include so-called “plant-based” products because such products may include ingredients sourced from animals—are distinguished from the “plant-only” meat- or seafood-analogue (imitation) food products, or other savory food products featuring an umami flavoring. These terms are discussed in more detail and the categories distinguished further below.

Commercially available food products are often highly processed and may contain meat or seafood flesh or other animal-sourced products in addition to added saturated fats, highly processed ingredients, synthetic additives and/or other ingredients that may be inappropriate for certain diets, e.g., vegetarian, vegan, salt-restricted, low-fat, low saturated fat, culturally- or religiously-restricted diets, etc.

Even some commercially available “plant-based,” “plant-derived,” food products (depending on how those terms are defined by the manufacturers, or under definitions supported by a governmental authority in the location of manufacture) may contain animal-derived ingredients, which can render even “plant-based” products inappropriate for vegetarians and vegans.

Some flavoring agents have been developed to mimic the qualities that consumers of plant-based alternatives desire in a food product without altering its texture, behavior at different temperatures and stability over time.

Examples of food additives commonly found in commercially available flavorings used in other food products are modified starches, sorbitol, glutamate and polyphosphates.

The umami flavor replacement system is not intended to be consumed as is. Rather, the system is preferably mixed with other ingredients and possibly other plant-only replacement systems disclosed elsewhere in a food product, which, may be incorporated into other food products. The consumable food products may be plant-only food products, or even animal flesh-based food products.

Many such additives (particularly synthetic additives) could be harmful to consumers if consumed over prolonged periods. The food industry uses more than 7,000 synthetic and ultra-processed additives even though nature offers more than ten million compounds from more than 450,000 plants.

It would be desirable to provide solely plant- or fungi-derived, or other natural source-derived ingredients that are not from the animal kingdom (hereafter, “plant-only”) that replace highly processed, synthetic, artificial and/or animal-derived (i.e., sourced directly or indirectly from an animal), commercially available flavoring agents.

Therefore, there is a need to develop of plant only umami flavoring replacement system in food products.

### SUMMARY OF THE DISCLOSED EMBODIMENT

An aspect of the disclosed embodiment of plant only umami flavoring replacement system in food products.

According to the aspect of disclosed embodiment, a plant-only umami flavoring replacement system for use in food products comprising: a) 5-15% by weight of a fruit source, b) 10-35% by weight of a fungal source, c) 5-15% by weight of a vegetable source, d) 5-10% by weight of an aquatic plant source, e) 5-15% by weight of a bulb source and f) 5-10% by weight of spice and herb plant source.

According to one embodiment, the plant-only umami flavoring replacement system, wherein the fruit source is selected from tamarillo, strawberries, blueberries, apricots, cherry tomatoes, pineapple, plum, barbados cherry, pomelo, peach or combinations thereof.

According to another embodiment, the plant-only umami flavoring replacement system, wherein the fungal source is selected from shiitake mushroom, maitake mushroom, portobello mushroom, porcini mushrooms, morel mushrooms, enoki mushrooms, oyster mushrooms, chanterelle mushrooms, truffle mushrooms, lion's mane mushroom or combinations thereof.

According yet another embodiment, the plant-only umami flavoring replacement system, wherein the vegetable source is selected from asparagus, broccoli, bell peppers, chili peppers, celery, spinach, brussel sprouts, beetroot, cabbage, carrots or combinations thereof.

According yet another embodiment, the plant-only umami flavoring replacement system, wherein the aquatic plant source is selected from sugar kelp, kombu, water spinach, watercress, cattail shoots, sea beans, water bamboo, water mimosa, water lily, kangkong, Gracilaria verrucosa, lotus root, water chestnut, red weed or combinations thereof.

According yet another embodiment, the plant-only umami flavoring replacement system, wherein the bulb source is selected from onion, garlic, shallot, leek, scallion, fennel bulb, celery bulb, kohlrabi, Jerusalem artichoke, garlic chives, Chinese chives, elephant garlic or combinations thereof.

According yet another embodiment, the plant-only umami flavoring replacement system, wherein the spice and herb plant source is selected from cumin, coriander, paprika, caraway, carom bay leaves, ginger root, turmeric root, black peppers, rosemary, peppermint, thyme, Mentha spicata, angelica, caper, marjoram or combinations thereof.

According yet another embodiment, the plant-only umami flavoring replacement system, wherein the food products comprise soups, sauces, marinades, meats, vegetables, and snacks.

According to the aspect of the disclosed embodiment, a method for preparing a plant-only umami flavoring replacement system for use in food products, wherein the method comprises: mixing a) 5-15% by weight of a fruit source, b) 10-35% by weight of a fungal source, c) 5-15% by weight of a vegetable source, d) 5-10% by weight of an aquatic plant source, e) 5-15% by weight of a bulb source and f) 5-10% by weight of spice and herb plant source at a temperature between 60 degrees Celsius and 105 degrees Celsius for about 30 seconds to one minute to form the plant-only umami flavoring replacement system.

According to yet another embodiment, a method for preparing a plant-only umami flavoring replacement system for use in food products, wherein the fruit source, the fungal source, the vegetable source, the aquatic plant source, the bulb source, and the spice and herb plant source are obtained in powdered form.

According to yet another embodiment, a method for preparing a plant-only umami flavoring replacement system for use in food products, wherein the fruit source is selected from tamarillo, strawberries, blueberries, apricots, cherry tomatoes, pineapple, plum, barbados cherry, pomelo, peach or combinations thereof.

According to yet another embodiment, a method for preparing a plant-only umami flavoring replacement system for use in food products, wherein the fungal source is selected from shiitake mushroom, maitake mushroom, portobello mushroom, porcini mushrooms, morel mushrooms, enoki mushrooms, oyster mushrooms, chanterelle mushrooms, truffle mushrooms, lion's mane mushroom or combinations thereof.

According to yet another embodiment, a method for preparing a plant-only umami flavoring replacement system for use in food products, wherein the vegetable source is selected from asparagus, broccoli, bell peppers, chili peppers, celery, spinach, Brussel sprouts, beetroot, cabbage, carrots or combinations thereof.

According to yet another embodiment, a method for preparing a plant-only umami flavoring replacement system for use in food products, wherein the aquatic plant source is selected from sugar kelp, kombu, water spinach, watercress, cattail shoots, sea beans, water bamboo, water mimosa, water lily, kangkong, Gracilaria verrucosa, lotus root, water chestnut, red weed or combinations thereof.

According to yet another embodiment, a method for preparing a plant-only umami flavoring replacement system for use in food products, wherein the bulb source is selected from onion, garlic, shallot, leek, scallion, fennel bulb, celery bulb, kohlrabi, Jerusalem artichoke, garlic chives, Chinese chives, elephant garlic or combinations thereof.

According to yet another embodiment, a method for preparing a plant-only umami flavoring replacement system for use in food products, wherein the spice and herb plant source is selected from cumin, coriander, paprika, caraway, carom bay leaves, ginger root, turmeric root, black peppers, rosemary, peppermint, thyme, Mentha spicata, angelica, caper, marjoram or combinations thereof.

According to yet another embodiment, a method for preparing a plant-only umami flavoring replacement system for use in food products, wherein the food products comprise soups, sauces, marinades, meats, vegetables, and snacks.

According to yet another embodiment, a method for preparing a plant-only umami flavoring replacement system for use in food products, wherein physical characterization data associated with ingredients of the plant-only umami flavoring replacement system comprising the fruit source, the fungal source, the vegetable source, the aquatic plant source, the bulb source, and the spice and herb plant source is stored in a database, wherein a machine learning model determines a unique combination of ingredients based on the physical characterization data to prepare the plant-only umami flavoring replacement system.

According to yet another embodiment, a method for preparing a plant-only umami flavoring replacement system for use in food products, wherein the physical characterization data of the ingredients comprise functional properties that comprise emulsification properties, stabilization properties, gelling properties, fat-replacement properties, Ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.

Several aspects of the invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

### BRIEF DESCRIPTION OF THE DRAWINGS

The foregoing and other objects and features of the disclosed embodiment will become more fully apparent from the following description and appended claims, taken in conjunction with the accompanying drawings. Understanding that these drawings depict only typical embodiments of the disclosed embodiment and are, therefore, not to be considered limiting of its scope, the disclosed embodiment will be described with additional specificity and detail through use of the accompanying drawings briefly described below:

FIG. 1 is a flowchart that illustrates the method involved in preparation of umami flavoring, according to the aspect of the disclosed embodiment.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE DISCLOSED EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another. Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, i.e., edible compounds sourced from plants, fungi or algae that comprise one or more naturally occurring chemical compounds.

Alternative embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

As used herein, the singular forms “a”, “an”, and “the” include both singular and plural referents unless the context clearly dictates otherwise. By way of example, “a dosage” refers to one or more than one dosage.

The terms “comprising”, “comprises” and “comprised of” as used herein are synonymous with “including”, “includes” or “containing”, “contains”, and are inclusive or open-ended and do not exclude additional, non-recited members, elements or method steps.

All documents cited in the present specification are hereby incorporated by reference in their totality. In particular, the teachings of all documents herein specifically referred to are incorporated by reference.

Example embodiments of the disclosed embodiments are described with reference to the accompanying FIGURES.

In the drawings, like reference numbers generally indicate identical, functionally similar, and/or structurally similar elements. The drawing in which an element first appears is indicated by the leftmost digit(s) in the corresponding reference number.

### Definitions

The term “Umami” refers to a category of taste in food (besides sweet, sour, salt, and bitter), corresponding to the flavor of glutamates, especially monosodium glutamate.

The term “Starch” refers to a polymeric carbohydrate consisting of numerous glucose units. The term “Blender” refers to an appliance used to mix, crush, purée or emulsify food and other substances.

The term “FDA” refers to Food and Drug Administration

The term “Machine learning model” refers to computer software designed to recognize patterns or behaviors based on previous experience or data.

The term “Plant-based” refers to largely or solely of vegetables, grains, pulses, or other foods derived from plants, rather than animal products.

The term “Frozen” refers to liquid form turned into ice as a result of extreme cold.

The term “Plant-derived” refers to ingredients extracted from a plant.

The term “Plant-only” products disclosed herein, as opposed to products labeled as “plant-based,” and the like, refer to food products whose ingredients, apart from any significant amount of water added, are derived solely from sources outside of the animal kingdom, e.g., from plants, fungi, or algae. That is, “plant-only” may refer to any composition, formulation, system or the entire food product, that is produced, developed, or otherwise obtained directly or indirectly from one or more plants, fungi, or algae, is not synthetic, and is only minimally processed for production, e.g., cleaned, dried, pulverized, etc.

The term “food product” refers broadly to any edible food or product, raw or cooked, savory or sweet, whether intended for human or animal consumption; a food product may be edible although not intended to be consumed on its own but, rather, incorporated into a second (or third) food product that is considered a consumable.

The Applicant, Live Green Company, is the market maker of the Plant-only category, which means that all the animal, synthetic and ultra-processed ingredients are replaced by plant-derived ingredients with superior nutritional profiles without impacting the original organoleptic properties.

The umami flavor replacement system is not intended to be consumed as is. Rather, the system is preferably mixed with other ingredients and possibly other plant-only replacement systems disclosed elsewhere in a food product, which, it may be, incorporated into other food products. The consumable food products may be plant-only food products, plant-based food products, or even animal flesh-based food products.

The Applicant, Live Green Company, is the market maker of the Plant-only category, which means that all the animal, synthetic and ultra-processed ingredients are replaced by plant-derived ingredients with superior nutritional profiles without impacting the original organoleptic properties.

Embodiments disclosed herein include the plant-only umami flavor replacement system, or components of it, for replacing various ingredients or combinations of ingredients traditionally found in commercially available food products. In some embodiments the umami flavoring replacement system is a stand-alone food product that may be consumed as a seasoning on or incorporated into other food products. In certain embodiments the umami flavoring replacement system is a component in the meat-based or imitation meat-based food products; in other embodiments, the umami flavoring replacement system is a component of seafood or imitation seafood food products. In other embodiments, the umami flavoring replacement system is used to enhance the nutritional or aesthetic value of the food product. In other embodiments the umami flavoring replacement system's plant-only ingredients may replace any-even partially-animal-derived ingredients of so-called “plant-derived,” plant-based,” or “meatless” food product, including food product mixes.

“Plant-only” products disclosed herein, as opposed to products labeled as “plant-derived,” “plant-based,” and the like, refer to food products whose ingredients, apart from any significant amount of water added, are derived solely from sources outside of the animal kingdom, e.g., from plants, fungi, or algae. That is, “plant-only” may refer to any agent, ingredient, or component of a food product, or the entire food product itself, that is produced, developed, or otherwise obtained directly or indirectly from one or more plants, fungi, or algae, is not synthetic, and is only minimally processed for production, e.g., cleaned, dried, pulverized, etc.

While some manufacturers may refrain from including any ingredients sourced from animals in their “plant-based” (and other similarly labeled) products, the term “plant-based” may also encompass ingredients and food products that may be obtained from animals. The US Food and Drug Administration currently has no accepted standard definition for labeling of food products described as “plant-based” or “plant-derived,” although a private trade organization, the Plant Based Food Association, has proposed voluntary standards to ensure consistency when the term “plant-based” is used on a product label (i.e., it contains no animal-sourced content), and seeks to certify—through its own certification process—food products, including food product mixes, that meet this standard See https://www.plantbasedfoods.org/icy/labeling/. The terminology used on a label for a plant-based food must be truthful under FDA regulations; however, in the US, no regulatory body currently requires a company to refrain from including some amount of meat, seafood, or other animal-sourced ingredients in a “plant-based” product.

The term “food product” refers broadly to any edible good or product, raw or cooked, savory or sweet, whether intended for human or animal consumption; a food product may be edible although not intended to be consumed on its own but, rather, incorporated into a second (or third) food product that is considered a consumable. The umami flavoring replacement system disclosed herein in certain embodiments may be incorporated into or used with meat-based food products; in other embodiments it may be incorporated into or used with seafood-based food products; in still other embodiments, it may be incorporated into or used with plant-based food products. In certain preferred embodiments, the umami flavoring replacement system may be incorporated into or used with plant-only food products.

In certain embodiments, while some of the water content of a food product may be derived from a plant source, water may also be added to the product from an external source. For example, in scenarios in which a plant only agent or system or plant only food product is in the form of a gel or liquid, it is further understood that water can be included as solvent or liquid carrier for the plant-only system, ingredient or food product, where any amount of water (some or all) within the system, ingredient or food product may or may not be derived from a plant source. In some embodiments, water may be added from an external source as part of the plant-only umami flavoring replacement system (or any other plant-only replacement system referenced herein). In other embodiments the plant only flavoring replacement system may be available in a dried form; in certain embodiments the dried form may be powdered; in other embodiments, the dried form of the flavoring replacement system may be in a partially powdered form; in other embodiments it may be available in a semi-liquid or gel form; in other embodiments it may be in a liquid or frozen form.

In the disclosed embodiments, apart from externally-sourced water, the plant-derived food product consists entirely of ingredients derived from plants, fungi or algae, excluding any component or ingredient that is: (i) dairy-based or otherwise derived from any member of the animal kingdom; and (ii) more than minimally processed; and (ii) synthetic.

### EMBODIMENTS OF THE DISCLOSED EMBODIMENT

The disclosed embodiment is in the technical field of plant only umami flavoring replacement system in food products.

In an embodiment, the term “Umami” refers to a category of taste in food (besides sweet, sour, salt, and bitter), corresponding to the flavor of glutamates, especially monosodium glutamate.

### Functionality and Parameters

TABLE 1
Parameter ranges associated with ingredients of the plant-
only umami flavoring replacement system in food products

| Categories | Parameters and Ranges | | | |
|---|---|---|---|---|
| Fruit | Primary | Balance of non- | | Flavor |
| source(s) | bioactive | volatile and | | Aromatics: |
| | compounds | volatile | | Fruity |
| | responsible for | constituents | | notes, |
| | umami flavor | that contribute | | Pungency, |
| | Glutamate and | to taste and | | milk/dairy |
| | aspartate (both, | aroma: | | like |
| | amino acids), | Sweetness: | | flavor |
| | glutamate and | fructose (1.2) > | | aromatics. |
| | proline (Glu-Pro- | sucrose (1.0) > | | |
| | Glu), and | glucose (0.64). | | |
| | glutamate and | Sourness or | | |
| | aspartate (Glu- | acidity is | | |
| | Asp). | determined by | | |
| | | the | | |
| | | concentrations of | | |
| | | the predominant | | |
| | | organic acids, | | |
| | | which are ranked | | |
| | | relative to citric | | |
| | | acid in the | | |
| | | following order | | |
| | | of sourness: | | |
| | | citric (1.0) > | | |
| | | malic (0.9) > | | |
| | | tartaric (0.8); | | |
| | | Some amino | | |
| | | acids, such as | | |
| | | aspartic and | | |
| | | glutamic, may | | |
| | | also contribute to | | |
| | | sourness. | | |
| Fungal | Primary | Average Free | Number | Flavor |
| source(s) | bioactive | amino acid | of | Aromatics: |
| | compounds | concentration: | C8 | Umami, |
| | responsible for | 120.79 mg g−1 | compounds: | Savory, |
| | umami flavor | (Asp-Glu-Ser) | 22- | Earthy, |
| | di- and tri- | concentration | 150 | smoky |
| | peptides of | Shitake | (depends | flavor |
| | glutamates: | Mushroom: (2, | on | |
| | glutamate and | 15.68, 1.63) mg | The | |
| | aspartate (Glu- | g−1 | method). | |
| | Asp) or aspartate, | portobello | | |
| | glutamate and | mushroom: | | |
| | serine (Asp-Glu- | (16.13, 17.96, | | |
| | Ser) | 11.11) mg g−1 | | |
| | | Oyster | | |
| | | mushrooms: (6.45, | | |
| | | 36.85, 8.99) mg | | |
| | | g−1 | | |
| Vegetable | Primary | Amino acids | Amino | Flavor |
| source(s) | bioactive | identified in the | acids | Aromatics: |
| | compounds | vegetable | conc.: >0.45 | Pungent, |
| | responsible for | sources: 17-20 | μg/mgd | earthy, |
| | umami flavor | Presence of | Asparagus: | greeny, |
| | Free amino acids, | Dimethyl Sulfide | Glu- | mildly |
| | asparagine and | Free Amino Acids | Asp: | bitter, |
| | glutamate and the | conc.: 1.85% w/w | (0.45, | Umami |
| | dipeptides, | Asparagine: | 0.32) | and savory |
| | glutamate/aspartate | 30.3% | μg/mgd. | flavor |
| | (Glu-Asp), and | Glutamic acid: 1- | Broccoli: | |
| | cysteine/methionine | 3% | (Cys- | |
| | (Cys-Met). | Free Amino Acid | Met): | |
| | | conc.: 20 mmol | 6.22 | |
| | | g−1 dry weight | mg/100 | |
| | | glutamic acid: | mg | |
| | | 16.27 to 18.43 | of | |
| | | mg/100 mg | protein | |
| | | protein | Bell | |
| | | Total Amino | Peppers: | |
| | | Acids: 7.0 to | Glu- | |
| | | 1,625.3 mg/100 g | Asp: | |
| | | Glutamic Acid: | (10.8, | |
| | | 9.34-14.4% | 3.1) | |
| | | | (Cys- | |
| | | | Met): | |
| | | | (1.38, | |
| | | | 0.67) | |
| Aquatic | Primary | Glutamic acid | EUC | Flavor |
| plant | bioactive | conc: | (Equivalent | Aromatics: |
| source(s) | compounds | (3-145) mg/100 g | umami | Salty, |
| | responsible for | Kombu: | conc) | umami, |
| | umami flavor | 145 mg/100 g | value: | earthy, |
| | Glutamic acid and | Sugar kelp: | 0.9 | same |
| | sodium salt | 3 mg/100 g | to | like |
| | | Dulse: 40 | 285 | mono |
| | | mg/100 g | gMSG/ | sodium |
| | | Graceful red | 100 | glutamate |
| | | weed: 6 mg/100 g | g DW | |
| | | | N. oceanica: | |
| | | | 0.4 | |
| | | | gMSG/ | |
| | | | 100 | |
| | | | g DW | |
| | | | P. tricornutum: | |
| | | | 285 | |
| | | | gMSG/ | |
| | | | 100 | |
| | | | g DW | |
| | | | S. costatum | |
| | | | (219 | |
| | | | gMSG/ | |
| | | | 100 | |
| | | | g DW. | |
| Bulb | Primary | TAV (Threshold | | Flavor |
| source(s) | bioactive | Aroma Value): >0.01 ppm | | Aromatics: |
| | compounds | Minimum | | Pungent, |
| | responsible for | concentration of a | | Umami, |
| | umami flavor | volatile organic | | Earthy, |
| | allyl sulfide, free | compound | | Fresh |
| | (amino acids) | required to detect | | |
| | glutamate and | a specific aroma | | |
| | aspartate, and its | or flavor note. The | | |
| | dipeptide | TAV values of | | |
| | (glutamate and | dimethyl | | |
| | aspartate (Glu- | trisulfide, hexanal, | | |
| | Asp)); and | and alkyl | | |
| | tripeptide | pyrazines can vary | | |
| | (aspartate, | depending on the | | |
| | glutamate and | specific compound | | |
| | serine (Asp-Glu- | and the source of | | |
| | Ser)) | the vegetable. | | |
| | | Garlic: dimethyl | | |
| | | trisulfide in garlic | | |
| | | is estimated to be | | |
| | | around 0.01 ppm. | | |
| | | Onions: dimethyl | | |
| | | trisulfide in onions | | |
| | | is estimated to be | | |
| | | around 0.02 ppm. | | |
| Spices and | Primary | Content of major | Effect | Flavor |
| herb plant | bioactive | flavor amino | of | Aromatics: |
| source(s) | compounds | acids/compounds | Umami | peppery |
| | responsible for | by HPLC profile | components | and |
| | umami flavor: | in percentage: | (EUC | sweet, |
| | Glutamic acid, | Ginger root: | (gMSG/ | with |
| | P-cresol and | Aspartic Acid: | 100 | a |
| | Limonene (4- | 29.80% | g) | pungent |
| | Methyl phenol), | Glutamic Acid: | 3- | and |
| | glutamic acid, | 35.8% | 83% | spicy |
| | aspartic acid, | Rosemary: | | aroma |
| | proline and other | Aspartic acid: 4.77 | | and |
| | related | to 15.75% | | umami |
| | compounds. | Coriander leaves: | | taste |
| | | 1-Decanol: 20% | | |
| | | Peppermint: | | |
| | | Menthol: 46% | | |
| | | M. spicata: | | |
| | | Limonene: 37% | | |

In an embodiment, the selection of a specific combination of ingredients for plant-only products was determined using a proprietary machine learning (ML) tool, which blends ancestral wisdoms of plant nutrition with biotechnology and ML to analyze members of, primarily, the plant and fungi kingdoms, as well as other potential, natural, sources outside of the animal kingdom for the compounds nature offers.

The platform utilizes algorithms and includes a database with a significant number of ingredients (e.g., 50,000-100,000 ingredients) and relevant physical properties associated with such ingredients.

For example, physical characterization data and information about each ingredient for some or all of the ingredients in the database include, without limitation, functional properties (e.g., emulsification properties, stabilization properties, bulking properties, texturizing properties, gelling properties, fat-replacement properties, etc.) and aesthetic properties relating to flavorings.

Ayurvedic and/or other holistic properties, physicochemical properties (e.g. pH, viscosity, moisture content, density, etc.), mechanical properties (e.g. adhesive strength, tensile strength, shear resistance, etc.), chemical and/or molecular descriptor properties (e.g., bio-active/bioavailability properties, molecular structure, phytonutrient properties, etc.), sensorial properties (e.g., taste, smell, color, texture, mouth feel, etc.), and nutritional information (e.g., macronutrient/micronutrient properties, etc.) are also considered in the proprietary system to give optimal results in terms of functionality, health and sustainability.

Based upon the known properties of ingredients in the database, the desired properties for the food product or formulation, and one or more algorithms associated with the proprietary machine learning platform, a unique combination of plant-only ingredients was determined to yield an effective flavoring replacement formulation that can be used to create a desirable food product or formulation that is effective as a substitute for conventional ingredients in food products of all kinds.

As noted, the proprietary system identifies natural alternatives, i.e., as defined, “plant-only” alternatives to synthetic, artificial, and animal-derived products, and incorporates in its algorithms, among other things, traditional knowledge known as Ayurvedic medicine.

Ayurvedic medicine and its diet principles have been practiced for many thousands of years. This ancient system, among other things, categorizes food by its medicinal properties and desired effects; thus, the proper application of Ayurvedic principles requires knowledge of the self—one's dominant energy, also known as dosha—to prescribe the most advantageous categories of foods from which to choose for an individual's diet.

Categories of Ayurvedic properties include but are not limited to Virya (hima/sheeta—cold), Vipaka (Madhura—sweet), Rasa (Madhura—sweet), and Guna (ruksa—dry; or guru-heavy). The information recommended by the proprietary Machine learning system permits one to choose among hundreds of alternatives based on ingredients intended to alter a variety of properties to give optimal results for aesthetic purposes (i.e., flavorings, mouthfeel, etc.) as well as physiological functionality, health, and environmental sustainability.

A food product flavoring replacement system as described herein functions to replace synthetic or artificial additives and flavorings and comprises a combination of plant- or fungi-, or algae-sourced ingredients and added water, if any is required for their preparation. The plant-only ingredients and combinations of ingredients selected for the flavoring replacement system are consistent with the requirements and specifications of achieving the sensory features exhibited by convention flavoring agents.

### Plant-Only Umami Flavor Replacement System

The Japanese term “umami” refers to a taste that is “meaty, rich, savory and satisfying” Initially it was thought that the flavor was the result of the presence of an amino acid, glutamate (also known as glutamic acid), one of the building blocks of peptides and proteins.

It was known that our taste buds had taste receptors in particular areas on our tongues that detected only the four basic tastes (salty, sweet, sour and bitter) and it was thought that all other components of flavor were experienced through the olfactory sense.

In fact, the term “umami” accurately describes the flavor of several amino acids and proteins found in foods. A taste receptor specific to the “umami” flavor was discovered in the last few decades, metabotropic glutamate receptor type 4 variant (“taste-mGlueR4”), clarifying that the umami flavor is in fact a fifth basic taste in humans, accompanying the more recognized four traditional tastes.

### EXAMPLE EMBODIMENTS

The disclosed embodiment will be further described in the following examples. It should be understood that these examples are for illustrative purposes only and are not to be construed as limiting this disclosed embodiment in any manner.

TABLE 2
Preferred, Essential Plant-Only Umami Flavoring
Replacement System Categories/Ingredients

| Preferred, Essential | | |
|---|---|---|
| Plant-Only Umami | | |
| Flavoring | | Preferred Weight |
| Replacement System | | Percent of the |
| Categories/Ingredients | Ingredients | Replacement System |
| Category 1. Fruit | blueberries, | 5-15 |
| source(s): any one or | strawberries, apricots, | |
| more of Tamarillo, | cherry tomatoes, | |
| Strawberries, and/or | Pineapple, Tamarillo, | |
| one or more substitutes | Plum, Barbados | |
| imparting the same | cherry, Pomelo, Peach | |
| properties and | | |
| functionalities | | |
| Category 2. Fungal | Porcini mushrooms, | 10-35 |
| source(s): any one or | Morel mushrooms, | |
| more of shiitake | Enoki mushrooms, | |
| mushroom, maitake | Oyster mushrooms, | |
| mushroom, portobello | Chanterelle | |
| mushroom, and/or one | mushrooms, Truffle | |
| or more substitutes | mushrooms, Lion's | |
| imparting the same or | Mane mushroom, | |
| similar flavorings, | shiitake mushroom, | |
| properties and/or | maitake mushroom, | |
| functionalities | portobello mushroom | |
| Category 3. | bell peppers, chili | 5-15 |
| Vegetable source(s): | peppers, celery, | |
| any one or more of | spinach, Brussel | |
| asparagus, broccoli | sprouts, beetroot, | |
| and/or one or more | cabbage, carrots, | |
| substitutes imparting | asparagus, broccoli | |
| the same or similar | | |
| flavorings, properties | | |
| and/or functionalities | | |
| Category 4. Aquatic | Water spinach, | 5-10 |
| plant source(s): any | Watercress, Cattail | |
| one or more of lotus | Shoots, Sea beans, | |
| root, water chestnut, | water bamboo, water | |
| and/or one or more | mimosa, water lily, | |
| substitutes imparting | kangkong, Gracilaria | |
| the same or similar | verrucosa, water | |
| flavorings, properties | chestnut, Red weed, | |
| and/or functionalities | Sugar kelp, Kombu | |
| Category 5. Bulb | Shallot, Leek, | 5-15 |
| source(s): any one or | Scallion, Fennel bulb, | |
| more of onion, garlic, | Celery bulb, Kohlrabi, | |
| and/or one or more | Jerusalem artichoke, | |
| substitutes imparting | Garlic chives, Chinese | |
| the same or similar | chives, Elephant | |
| flavorings, properties | garlic, onion, garlic | |
| and/or functionalities | | |
| Category 6. Spices | ginger root, turmeric | 5-10 |
| and herb plant | root, black peppers, | |
| source(s): any one or | rosemary, Peppermint, | |
| more of cumin, | thyme, M. spicata, | |
| coriander, paprika, | Angelica, Caper, | |
| caraway, carom, bay | Marjoram, cumin, | |
| leaves and/or one or | coriander, paprika, | |
| more substitutes | caraway, carom bay | |
| imparting the same or | leaves | |
| similar flavorings, | | |
| properties and/or | | |
| functionalities | | |

In an embodiment, within each of the six categories in Table 2, one of the listed ingredients (or one or more plant-only alternatives to that ingredient, which alternatives impart the same or similar flavor as the replaced ingredient) may be used as the umami flavor replacement system.

In other embodiment, two or more listed ingredients (or their plant-only alternatives, as above) may be combined in varying amounts for the replacement system.

In certain embodiment, one or more representative ingredients from each of the six categories are mixed to form the replacement system.

In alternative embodiment, any of the ingredients listed in Table 2 may be replaced by one or more plant-only substitute ingredients (not listed) that impart the same or similar flavors and/or properties and functionalities to the food product as the ingredient(s) being replaced.

In an embodiment, although Table 2 provides a preferred essential list of categories of ingredients imparting particular variety of flavorings in the umami flavoring replacement system, substitutions for these ingredients in the replacement system may be made in alternative embodiments for compliance with dietary requirements, without limitation, such as food sensitivities and food allergies.

The umami flavoring replacement system detailed in Table 2 as a component of another food product (such as a meat- or seafood-based, or imitation meat or seafood product, or other savory food product) comprises generally between about 5 to about 15 percent dry weight of the total weight of the food product, but may vary between as much as less than 1 percent to more 20 percent or more of the total weight, depending on the moisture content of the flavoring replacement system and that of a consumable food product in which it is incorporated or with which it is used.

The umami flavoring replacement system may comprise, as a percent by weight of the food product to which it is added, and depending on the type of food product and whether water or other liquid is included as part of the food product, between about 0.5 to about 20 percent or more, between about 0.5 and about 2 percent, between about 0.5 and 4 percent, between about 0.6 to about 0.8 percent, between about 0.8 to about 1 percent, between about 1 to about 1.2 percent, between about 1.2 to about 1.4 percent, between about 1.4 to about 1.6 percent, between about 1.6 to about 1.8 percent, between about 1.8 to about 2.0 percent, between about 2.0 to about 2.5 percent, between about 2 to about 3 percent, between about 3 to about 5 percent, between about 5 and 15 percent, between about 5 to about 7 percent, between about 6 to about 8 percent, between about 7 to about 10 percent, between about 9 and about 12 percent, between about 11 and about 14 percent, between about 13 to about 16 percent, between about 15 to about 20 percent or more of the total weight of the food product in which the replacement system is incorporated

### Categories of Ingredients Among the Preferred, Essential Categories of Ingredients in the Umami Flavoring Replacement System

TABLE 3
Categories of ingredients among the preferred, essential categories
of ingredients in the umami flavoring replacement system

| | Functionality | Compounds | | |
|---|---|---|---|---|
| | relating to | responsible for | Physicochemical | Ayurvedic |
| Ingredient | flavor | functionality | properties | properties |
| Category | Tamarillo, | L- | Moisture | Rasa: |
| 1: Fruit | a | glutamate | content: 81- | Madhura |
| source(s). | relative | (470-1200 | 87% | (Sweet), |
| Any one or | of the | mg/100 g), | pH: 3.84- | Guna: |
| more of | tomato, | γ- | 4.36 | Guru(heavy), |
| tarmarillo, | contains | aminobutyrate | Foaming | Virya: |
| strawberries | a high | and L- | capacity: | Sheeta |
| and/or | level of | aspartate | 32.19% | (cold), |
| any | glutamate, | dominates | Total | Vipaka: |
| substitutes | one of | the amino | acidity: | Madhura |
| imparting | the key | acid | 0.57-1.6% | (sweet) |
| the same or | amino | profile of | | |
| similar | acids | tamarillo. | | |
| flavorings, | responsible | | | |
| properties | for | | | |
| and/or | the | | | |
| functionalities | umami | | | |
| | flavor. | | | |
| Category | Dried | Mushrooms | Moisture: | Rasa: |
| 2: Fungi | (preferably | have a | 2.76% | Madhura |
| source(s). | sun- | characteristic, | Solubility: | (sweet), |
| Any one or | or heat- | umami | 99% | Guna: |
| more of | dried) | taste | Water | Guru |
| shitake, | shiitake | mainly due | activity: | (heavy), |
| maitake | mushrooms, | to the | 0.159 | Virya: |
| and | fresh | presence | | Sheeta |
| portobello | or dried | of MSG- | | (cold), |
| mushrooms | (and | like free | | Vipaka: |
| and/or any | powdered) | amino | | Madhura |
| other fungi | enhance | acids such | | (sweet) |
| substitutes | the | as, L- | | |
| imparting | umami | aspartate | | |
| the same or | flavor of | and L- | | |
| similar | foods | glutamate | | |
| flavorings, | | | | |
| properties | | | | |
| and/or | | | | |
| functionalities | | | | |
| Category | Asparagus | The scaled | Moisture | Rasa: |
| 3: | is rich | tip of the | content: | Madhura |
| Vegetable | in the | spear is | 86.44% | (sweet), |
| source(s). | amino | richer in | pH: 6.0- | Tikta |
| Any one or | acid, | glutamate | 6.7 | (Bitter), |
| more of | asparagine, | (30-50 mg/ | Density: | Guna: |
| asparagus, | which is | 100 g) and | 566.38 g/l | Guru |
| broccoli | structurally | sugar than | | (Heavy), |
| and/or any | similar | the lower | | Snigdha |
| substitutes | to | part. | | (oily), |
| imparting | glutamine, | | | Virya: |
| the same or | glutamate | | | Sheeta |
| similar | and | | | (Cold), |
| flavorings, | aspartate | | | Vipaka: |
| properties | | | | Madhura |
| and/or | | | | (Sweet) |
| functionalities | | | | |
| Category | Lotus | Glutamic | Glutamic | Rasa: |
| 4: aquatic | root | acid and | acid | Kashya |
| plant | contains | starch | content: | (astringent), |
| sources: | glutamic | compounds | 100 mg/100 g | Madhura |
| Lotus | acid, | are | Moisture | (sweet), |
| (providing | responsible | responsible | content: | Titka |
| lotus root), | for | for the | 72.14% | (bitter), |
| with an | an | umami | pH: 5 | Virya: |
| umami | umami | flavor and | | Sheeta |
| flavor, | flavor, | mouth feel | | (cold), |
| water | and | | | Guna: |
| chestnuts, | starches, | | | Laghu |
| and/or | which | | | (lightness), |
| substitutes | impart a | | | Snigdha |
| with the | smooth | | | (oily), |
| same or | mouth | | | Picchila |
| similar | feel | | | (sticky), |
| flavorings, | | | | and |
| properties | | | | Vipaka: |
| and/or | | | | Madhura |
| functionalities | | | | (Sweet) |
| Category | Garlic is | Garlic | Moisture | Rasa: |
| 5: allium | a | contains | content: | Madhura |
| bulb | perennial | amino acid | 64% | (sweet); |
| source(s). | vegetable | glutamine | pH: 6.07 | Lavana |
| Garlic or | from | which aids | Density: | (salt), |
| any one or | the | in the | 892 to 1007 | Katu |
| more of | Allium | presence | kg/m3 | (Pungent); |
| onions | genus | of | (differs | Kashya |
| and/or | that | glutamate | based on | (astringent); |
| substitutes | provides | (100 mg/ | the bulb | Guna: |
| with the | a strong | 100 g) | size) | Snigdha |
| same or | umami | and | | (oily); |
| similar | flavor. | tyrosine to | | Guru |
| flavorings, | Its “heat” | enhance | | (heavy); |
| properties | or | the umami | | Teekshna |
| and/or | spiciness | flavor it | | (strong, |
| functionalities | is | imparts to | | piercing); |
| | attributable | foods. | | Virya: |
| | to | | | Ushna(hot); |
| | allyl | | | Vipaka: |
| | sulfide | | | Katu |
| | content. | | | (pungent) |
| | Garlic | | | |
| | also | | | |
| | contains | | | |
| | enzymes, | | | |
| | calcium, | | | |
| | copper, | | | |
| | iron, | | | |
| | manganese, | | | |
| | phosphorus, | | | |
| | potassium | | | |
| | and | | | |
| | selenium, | | | |
| | and | | | |
| | vitamins | | | |
| | A, C and | | | |
| | B1 | | | |
| | (thiamine), | | | |
| | B2 | | | |
| | (riboflavin), | | | |
| | and | | | |
| | B6. | | | |
| Category | Cumin | Glutamate | Moisture | Rasa: |
| 6: spice | contains | content: | content: 7- | Katu |
| and | glutamate | 2.8-3.2% | 22% d | (astringent), |
| herbsource(s). | (Glu) | Cumin | Density: | Guna: |
| Any | and | also | 1134 g/l | Laghu |
| one or | aspartate | contains | Porosity: | (easy to |
| more of | (Asp) | tyrosine | 64% | digest), |
| cumin, | and has a | which | | RukshaVirya: |
| coriander, | slightly | contributes | | Ushna |
| paprika, | sweet, | to a strong | | (Hot), |
| caraway, | warming, | umami | | Vipaka: |
| carom, bay | nut-like | flavor | | Katu |
| leaf and/or | flavor. | when | | (astringent) |
| any | Added | combined | | |
| substitutes | cumin | with | | |
| imparting | enhances | ingredients | | |
| the same or | the | containing | | |
| similar | umami | the amino | | |
| flavorings, | flavor in | acids, | | |
| properties | the food | aspartate | | |
| and/or | with the | and | | |
| functionalities | tone of | phenylalanine | | |
| | earthiness | | | |
| | in it. | | | |
| | Toasted | | | |
| | cumin | | | |
| | seeds | | | |
| | also | | | |
| | enhance | | | |
| | the | | | |
| | umami | | | |
| | flavor | | | |
| | profile | | | |

Preferred, essential ingredient categories and ingredients listed in Table 2 were identified by the machine learning system (referenced above) and exhibit the desired Ayurvedic properties, functionalities, and umami flavorings in preferred embodiments.

In other embodiments, one or more plant-only, minimally processed and non-synthetic alternative ingredients imparting the same or similar flavors may also be used in place of one or more (or all of) the listed ingredients to impart the same or similar flavorings as those replaced Table 3 categories and ingredients. There are several categories of ingredients contributing a variety of flavors through a selection of fruits, vegetables (including allium family members), fungi, spices and herbs.

A principal ingredient category in the umami flavoring replacement system for food products in particular is one or more fruits such as the tamarillo or strawberries, both high in glutamate and aspartate (also known as aspartic acid), two key umami flavoring amino acids.

### The Synergistic Effect of the Composition:

The present disclosure deals with plant-only umami flavoring replacement system which comprises of six ingredients i.e., (i) fruit source, (ii) fungal source, (iii) vegetable source, (iv) aquatic plant source, (v) bulb source, (vi) spices and herb source.

The major synergy is due to the interaction of amino acid and nucleotide.

In exemplary aspect, when these ingredients are combined, the reactions will create an umami rich food system. Tomatoes and shiitake mushrooms having nucleotides along with their umami amino acids will have internal umami synergy already taking place in them. While other ingredients such as asparagus, garlic, tamarillo, lotus stem, cumin might not have the possibility of internal umami synergy taking place. However, they have peptide combinations to aid them in the expression of umami flavour. When these ingredients are combined together, the nucleotides present in tomatoes and shiitake mushrooms contribute to the overall umami synergy of the system along with their internal interactions. Apart from the peptide combinations present, it also combines aspartic acid, phenylalanine and tyrosine to enhance the umami flavour. Aspartic acid from garlic, asparagus, tamarillo, mushroom, cumin and tomato; phenylalanine in asparagus, cumin, shiitake mushrooms, tomatoes; tyrosine in garlic and cumin all interact and help in the expression of high umami flavour. Overall, the combinations of the ingredients work together and help in the umami synergy to take place.

### Synergism Occurring in Human Mouth

When glutamate is given in combination with a consonant, savoury odour of vegetables, the resulting flavour which is formed by a convergence of the taste and olfactory pathways in the orbit frontal cortex is more satisfying. It is also found that the taste of IMP is probably caused by glutamic acid in saliva, since IMP itself has no umami taste. That is, IMP enhances the umami taste of MSG. mGluR1, mGluR4, and T1R1+T1R3 were identified to be receptor is for umami taste.

### Receptors of Umami Taste in Humans:

mGluR1, mGluR4, and T1R1+T1R3 were identified to be receptors for umami. T1R1+T1R3 exhibit a synergism between glutamate and 5′-inosinate or 5′-guanylate, but mGluR1 and mGluR4 do not exhibit the synergism. T1R1+T1R3 receptor: T1R1+T1R3 was identified to be an amino acid receptor. In humans, the synergism is seen between 5′-inosinate and only glutamate.

CATEGORY 1—FRUIT SOURCE(S): Tamarillo and/or strawberries are the preferred fruits of the disclosed umami flavoring replacement system. The tamarillo is a relative of the tomato and part of the nightshade family and, like tomatoes, tamarillos contain a high amount of glutamate (0.5-1.2 gram per 100 grams providing the umami taste) and aspartate (both, amino acids), which contribute to the umami flavoring of the replacement system. Additionally, peptide combinations present in the tamarillo such as glutamate and proline (Glu-Pro-Glu), and glutamate and aspartate (Glu-Asp) further add to the umami flavor. Unlike tomatoes, which grow on low bushes, Tamarillos grow on trees in warm climates and are eaten fresh and cooked in a variety of types of sweet and savory foods, and have a sweeter and tangier flavor, but similar texture, as a tomato. The consumption of tamarillos promotes the ayurvedic properties of Rasa: Madhura (Sweet); Guna: Guru (heavy); Virya: Sheeta (cold); and Vipaka: Madhura (sweet).

STRAWBERRIES in addition to or as a preferred alternative to tamarillos, are components in preferred embodiments of the umami flavoring replacement system. Strawberries comprise a group of several varieties of fruits (Fragaria genus) that are a part of the rose family. A wild or cultivated, seasonal fruit in the north, they may be grown worldwide at various times of the year and are eaten raw, cooked and dried (and powdered). Strawberries contain about 0.1 gram of glutamate per 100 grams of fresh fruit.

In some embodiments, tamarillos, strawberries and/or other fruits are dried and provided in the umami flavoring replacement system as a ground powder. In other embodiments the fruit(s) may be mixed with water, plant-derived liquid or other non-animal-sourced liquid to form a liquid, gel or other alternative form of the system suitable for mixing, storing, freezing and/or drying. In other embodiments, the fruits are provided in liquid or gel form. In still other embodiments, one or more substitute fruits for one or both of tamarillo and strawberries may be used in combination, or with (or substituted by) other ingredients known to a person of ordinary skill that would provide the same or similar flavorings (and perhaps characteristics and features (functionality and properties)) for this category in the system. Further detail on this category is found in Table 3.

In the disclosed embodiments the amount of fruits (one or more of tamarillo or strawberries, and/or one or more substitutes to have the same or similar flavors, and possibly also the same or similar properties and functionalities as these ingredients) as a percentage of the umami flavoring replacement system weight ranges between about 5 to about 7 percent, between about 7 to about 10 percent, between about 10 to about 15 percent, between about 5 to about 9 percent, between about 9 to about 12 percent, between about 12 to about 15 percent, between about 5 to about 10 percent, between about 7 to about 15 percent, between about 7 to about 11 percent, between about 8 to about 12 percent, between about 9 to about 13 percent, between about 10 and about 14 percent, and between about 12 to about 15 percent of the total weight of the umami flavoring replacement system.

### Synergy Due to Fruit Source

Tamarillo being the same family to tomato-Nightshade family has glutamic acid, aspartic acid that contributes to the major umami flavour in them. However, there are peptide combinations present: Glutamate and Proline (Glu-Pio-Glu) and Glutamate and Aspartate (Glu-Asp) that will also add to the umami flavoui. To a certain extent, γ-aminobutyric acid (GABA) also contributes to the umami flavour

CATEGORY 2—FUNGI SOURCE(S): Shitake, maitake and portabella (the latter, also known as cremini) mushrooms are the primary types of fungi in preferred embodiments of the disclosed umami flavoring replacement system. The flavor of fresh mushrooms is earthy and intensifies upon drying; adding dried mushrooms to foods is one way to achieve an earthy, umami flavor in the final food product with minimal effort. Among the varieties of dried mushrooms, porcinis and shitakes are common choices because of the rich and complex flavors they impart.

The characteristic taste of mushrooms is mainly due to the presence of free amino acids—aspartic and glutamic acid (glutamate), two of the building blocks of peptides and proteins. Further, various proteins recognize nucleic acid molecules. Some of them make tight complexes with DNA, RNA, and some bind dynamically and reversibly to nucleic acids. Amino acids that impart an umami flavor may recognize nucleotide bases (guanine, thymine, cytosine and uricil) in a variety of DNA/RNA binding and nucleotide binding proteins.

Nucleotides interact with amino acids present by ligand bonding creating a synergy between molecules that enhances umami flavors. In addition, combinations of free amino acids may contribute to the umami flavor.

Half dry processing under conditions of sun drying, spray drying or warm/hot air-drying SHITAKE MUSHROOMS contributes to a more intense umami flavor than does freeze drying. In dried shiitake mushrooms alone, di- and tri-peptides of glutamates: glutamate and aspartate (Glu-Asp) or aspartate, glutamate and serine (Asp-Glu-Ser) combinations are present. These combinations contribute to the intensity of the umami flavor. Shitake mushrooms promote the ayurvedic properties of: Rasa: Madhura (sweet); Guna: Guru (heavy); Virya: Sheeta (cold); and Vipaka: Madhura (sweet).

Preferred embodiments include other mushrooms that may be combined with or alternate for shitake mushrooms, including maitake and portobello (or portabella) mushrooms.

MAITAKE MUSHROOMS (also referred to as “hen of the woods,” “ram's head,” or “sheep's head”) are prized, delicate and earthy members of this category and are a component of preferred embodiments of the replacement system. Their taste is more delicate than a shitake mushroom and has a stronger, savory flavor than a porcini mushroom. Maitake mushrooms are more commonly found in small markets and at farmers markets, and dried versus fresh maitake mushrooms are easier to find.

PORTOBELLO (OR PORTABELLA) MUSHROOMS are a variety of mushroom from Agaricus bisporus, harvested at a mature stage of development when their water content is reduced and their flavors become more concentrated. When mature, these mushrooms are quite large (on average about 15 cm in diameter) dark brown in color and firm. At younger stages of maturation they are known as button mushrooms or crimini mushrooms.

Portobellos have a rich, savory, even meaty, umami flavor and a dense texture, and are typically cooked (grilled, fried, broiled, baked) for consumption; frequently they are used as a meat substitute. They can also be dried and pulverized and may serve as a broth or sauce flavoring, and a component in the umami flavoring replacement system. Additional information about shitake mushrooms can be found in Table 3.

In the disclosed embodiments the amount of fungi (one or more of shitake, maitake or portobello, and/or one or more substitutes to have the same or similar flavors, and possibly also the same or similar properties and functionalities as these ingredients) as a percentage of the umami flavoring replacement system weight ranges between about 10 to about 35 percent, between about 10 to about 15 percent, between about 15 to about 20 percent, between about 20 to about 25 percent, between about 25 to about 30 percent, between about 30 to about 35 percent, between about 12 to about 15 percent, between about 18 to about 22 percent, between about 23 and about 28 percent, and between about 29 to about 35 percent of the total weight of the umami flavoring replacement system.

### Synergy Due to Fungi Source

Shiitake mushrooms in the dried (sun dried, warm ari dried) form contribute to higher umami flavour. The characteristic taste of mushrooms is mainly due to the presence of free amino acids-aspartic and glutamic acid. Also, with respect to the nucleotides, it is observed that out of the six umami causing nucleotides, four major compounds are present. These include 5′-guanosine monophosphate, 5′-adenosine monophosphate, 5′-uridine monophosphate 5′-cytosine monophosphate. These nucleotides interact with the amino acids present by ligand bonding. By this process, umami synergy takes place in shiitake mushrooms enhancing the umami flavour multiple folds. Apart from the umami synergy, peptide combinations of the free amino acids have also been found to be helpful with the umami enhancement. In dried shiitake mushrooms, di, tripeptides of glutamates: Glutamate and aspartate (Glu-Asp), Aspartate, Glutamate and Serine (Asp-Glu-Ser), are present which again adds to the umami synergy. Mushrooms predominantly have an earthy taste.

CATEGORY 3—VEGETABLE SOURCE(S): Asparagus and broccoli are components of the preferred embodiments in the disclosed umami flavoring replacement system. Asparagus, Asparagus officinalis, is a member of the lily family; a perennial, seasonal plant cultivated in spring gardens primarily in the US, South America, Europe and China. The scaled tips of young shoots of the plant are harvested (at a height of ˜15 to 25 cm), cooked and consumed. Asparagus is rich in both of the key umami flavoring free amino acids, asparagine and glutamate and the dipeptides, glutamate/aspartate (Glu-Asp), and cysteine/methionine (Cys-Met). The flavor of asparagus in large part due to the presence of asparagine whose structure is similar to that of the amino acid, glutamine, because of their amide side chains. In addition, asparagine and glutamine differ by only one carbon atom each from aspartate and glutamate, respectively, two of the primary umami amino acids. In preferred embodiments, asparagus is dried and ground prior to incorporating into the replacement system. In other embodiments, along with other components of the replacement system, it is added directly to foods raw, cooked, dried or frozen. Roasting increases the compounds that enhance the umami flavor. Asparagus promotes the Ayurvedic properties of Rasa: Madhura (sweet); Tikta (bitter); Guna: Guru (heavy); Snigdha (oily); and Virya: Sheeta (cold).

BROCCOLI, Brassica oleracea, is a member of the cabbage family, a green, leafy plant with a flowering head or crown that is harvested before the flower head matures. It is grown in relatively cooler climates and consumed worldwide as a vegetable. It can be eaten raw, steamed, sautéed, stir-fried, roasted, grilled, fried, or pureed. In the preferred embodiments of the umami flavoring replacement system, broccoli is dried and ground prior to incorporating it into the replacement system with one or more of the other category ingredients. In other embodiments, along with other components of the replacement system, it is added directly to foods raw, cooked, dried or frozen. Broccoli is a good source of C, K, and B vitamins as well as the mineral, manganese. Alternatives to asparagus and broccoli include edamame, which is also a rich source of glutamate. Each ingredient may be interchanged with the others or may be used in combination of two or more of these ingredients, or with (or substituted by) other ingredients known to a person of ordinary skill that would provide the same flavorings, and possibly similar characteristics and features for this category in the system. Further detail on this category is found in Table 3.

In the disclosed embodiments the amount of vegetables (one or more of asparagus, broccoli and/or one or more substitutes to have the same or similar flavors, and possibly also the same or similar properties and functionalities as these ingredients) as a percentage of the umami flavoring replacement system weight ranges between about 5 to about 10 percent, between about 10 to about 12 percent, between about 12 to about 1 percent, between about 13 to about 15 percent, between about 5 to about 10 percent, between about 5 to about 15 percent, between about 7 to about 11 percent, between about 8 to about 12 percent, between about 9 to about 13 percent, between about 10 and about 14 percent, between about 12 to about 15 percent, between about 14 to about 15 percent, of the total weight of the umami flavoring replacement system.

### Synergy Due to the Vegetable Source:

Asparagus is rich in the free amino acids asparagine and glutamic acid. Also, there are peptide combinations present: Di-peptide Glutamate and aspartate (Glu-Asp), Cysteine and Methionine (Cys-Met) that help in the umami enhancement.

CATEGORY 4: AQUATIC PLANT SOURCE(S): Aquatic plants are those that have adapted to living in or around marine or fresh water, marshes, beaches, among mangroves, etc. The lotus is one example of an aquatic plant whose root (“lotus root”) is a rhizome—the bulb of the flower of the same name—is naturally low in fat, and is a good source of carbohydrates, fiber, vitamins and mineral to the umami flavor replacement system in food products. Alternatives to lotus root include water chestnuts and Salicornia herbaceae (also known as sea asparagus or sea beans, samphire or crow's foot), each of which may be interchanged with the others or may be used in combination of two or more of these ingredients, or with (or substituted by) other ingredients known to a person of ordinary skill that would provide the same flavorings, and possibly similar characteristics and features for this category in the system.

LOTUS ROOT contains glutamate, an organic acid that imparts an umami flavor; it also is high in antioxidants and phenolic compounds. In some embodiments, lotus root and other aquatic plant components may be provided in the seafood flavoring replacement system as a finely ground powder. Both dried and cooked lotus root enhance the umami flavor of a dish; in particular the half-drying process in the sun results in increased levels of glutamate and therefore an enhanced umami flavor. In other embodiments the lotus root powder or other form may be mixed with water, plant-derived liquid or other non-animal-sourced liquid to form a liquid, gel or other alternative form of the system suitable for mixing, storing, freezing and/or drying. Lotus root promotes the ayurvedic properties of Rasa: Kashaya (astringent), Madhura (sweet), Titka (bitter), and Virya: Sheeta (cold), Guna: Laghu (lightness), Snigdha (oily), Picchila (sticky), and Vipaka: Madhura (sweet). Further detail on lotus root is found in Table 3.

In the disclosed embodiments the dry weight amount of ingredient(s) sourced from aquatic plants and/or one or more substitutes that have the same or similar flavors, and possibly also the same or similar properties and functionalities as these ingredients, as a percent of the umami flavoring replacement system weight, ranges from between about 5 to about 10 percent, about 5 and about 6 percent, between about 5 to about 7 percent, between about 5 to about 8 percent, between about 5 and about 10 percent, between about 6 to about 8 percent, between about 7 to about 9 percent, between about 8 to about 10 percent, between about 9 to about 10 percent.

### Synergy Due to the Aquatic Plant Source

Lotus root—Glutamic acid is the major umami compound. The dried and cooked lotus roots impart more umami flavour than the raw samples. 5′-guanylate are responsible for umami taste/flavour Synergism between glutamate and 5′-nucleotides (5′-inosinate and 5′-guanylate) will impart a stronger flavour.

Raw Lotus stems contain 139 mg/100 g of glutamic acid. Even after cooking/drying there is no significant loss to the glutamic acid content (84 mg/100 g after cooking), also imparts more umami flavour Lotus root/stem (Source of glutamic acid) either alone or combined with other foods containing 5′-guanylate (mushrooms such as shiitake) or 5′-inosinate contributes to enhancement of umami flavour.

Category 5—allium bulb source(s): The alliums, onions (Allium cepa), and garlic (Allium sativum), are members of the lily family, along with chives, shallots, and leeks. Allium grow in bulbs underground and their flavors vary from mild to a intense, pungent and sometimes “hot” flavor attribute able to allyl sulfide, which mellows with cooking; their flavor is an essential component of cuisines worldwide as both a main ingredient and a seasoning. When the bulb flesh is cooked, cells break down and sugars are released, imparting sweetness to savory dishes. In the case of chives, garlic and spring onions, the green growth above the soil is used in many types of foods, in some cases as a main ingredient. Onion bulbs are multi layered in contrast to garlic bulbs, which have individual, sheathed cloves that grow around a center stalk. Both onions and garlic can be dried and diced or powdered for longer-term storage, use as a single seasoning, and incorporation to seasoning mixes such as the disclosed umami is flavoring replacement system.

Similar to the importance of onions to cuisines worldwide, garlic also is one of the most important culinary ingredients. Due to its intense and unique flavor it is primarily used as a flavoring agent. Like onions, garlic grows in the soil; its long green shoots (“scapes”) are edible and produce flowers. Alliums such as garlic also contain enzymes, minerals, vitamins A and C, B1, B2 and B6, as well as antioxidants and other compounds which combat inflammation. The umami flavor imparted by garlic, for example, derives from its elevated levels of free (amino acids) glutamate and aspartate, and its dipeptide (glutamate and aspartate (Glu-Asp)); and tripeptide (aspartate, glutamate and serine (Asp-Glu-Ser)) combinations in particular. Roasting garlic enhances the umami flavor that garlic imparts.

In some embodiments, onions and garlic may be provided in the umami flavoring replacement system as a finely ground powder.

In other embodiment's, onion and/or garlic powder or other form, such as an extract, may be mixed with water, plant-derived liquid or other non-animal-sourced liquid to form a liquid, gel or other alternative form of the system suitable for mixing, storing, freezing and/or drying. Alternatives to onion and garlic may include other members of the lily family such as leeks, shallots and chives. Each ingredient in this category may be interchanged with the others or may be used in combination, or with (or substituted by) other ingredients known to a person of ordinary skill that would provide the same or similar flavorings, and possibly similar characteristics and features for this category in the system. Garlic promotes the Ayurvedic properties of Rasa: Madhura (sweet); Lavana (salt), Katu (Pungent); Kashaya (astringent); Guna: Snigdha (oily); (heavy); Teekshna (strong, piercing); Virya: Ushna (hot); and Vipaka: Katu (pungent). Further detail on this category is found in Table 3.

In the disclosed embodiments the amount of allium bulbs (one or more of onions, garlic and/or one or more substitutes to have the same or similar flavors, and possibly also the same or similar properties and functionalities as these ingredients) as a percentage of the umami flavoring replacement system weight ranges between 5 to about 10 percent, between about 10 to about 12 percent, between about 12 to about 15 percent, between about 13 to about 15 percent, between about 5 to about 15 percent, between about 7 to about 11 percent, between about 8 to about 12 percent, between about 9 to about 13 percent, between about 10 and about 14 percent, between about 12 to about 15 percent, between about 14 to about 15 percent, of the total weight of the umami flavoring replacement system.

### Synergy Due to the Allium Bulb Source

Garlic has umami amino acids glutamic acid, aspartic acid. However, the peptide combinations help in the enhancement of umami flavour. They include the dipeptide and tripeptide of glutamate-Glutamate and Aspartate (Glu-Asp), Aspartate, Glutamate and Serine (Asp-Glu-Ser). These combinations help in the over all enhancement of umami flavours.

Category 6—spice and herb source(s): Spices are the dried parts of a plant other than the leaves that are used as a seasoning or flavoring in a food product but are not a main ingredient. Herbs are the dried or fresh leaves of plant used primarily in the same way although in some sauces, salads and condiments, herbs are frequently a main ingredient. One or more spices and herbs may be included as part of the umami flavoring replacement system in the disclosed embodiments. For example, any one or more (or all) of cumin, coriander, paprika, caraway, ajwain (carom), and/or bay leaf may constitute the spice and herb category of the replacement system.

In other embodiments, one or more of these may be replaced with an alternative herb or spice, or with a combination of alternative herbs and/or spices. Such substitutes (alternatives) would be known to a person of ordinary skill to provide the same or similar flavors, as well as properties, characteristics and/or functionalities as do the listed ingredients of this category. Further detail on this category is found in Table 3.

The popular spice, CUMIN, comes from the Cuminum cyminum, a member of the parsley family. Used in cooking as the dried seed or ground, either alone or frequently as a component in several types of splice blends, cumin is commonly used in Latin America, the Middle East, North Africa, and India. Cumin has a slightly sweet, warming and nut-like flavor, and toasting the seeds enhances the umami flavor that cumin imparts to foods. The seeds contain both glutamic acids (glutamate), aspartic acid (aspartate) as two of the most relevant amino acids (separately and when linked in a peptide) that contribute to the umami flavor. Other amino acid combinations include glutamate/proline (Glu-Pro-Glu), and cysteine/methionine (Cys-Met), both of which also bring out umami flavor imparted by cumin. Cumin promotes the Ayurvedic properties of Rasa: Katu (astringent); Guna: Laghu (easy to digest); Ruksa; Virya: Ushna (hot); and Vipaka: Katu (astringent).

CORIANDER is the seed of the coriander plant, Coriandrum sativum, also a member of the parsley family. The dried or fresh leaves of the plant are known as cilantro or Chinese parsley. Both frequently are used in Asian, Latin American and Indian cooking. Coriander imparts a lemony and floral essence, and also frequently is used in spice mixtures such as garam masala.

CAROM, also referred to as ajwain or bishops weed, like cumin and coriander, is part of the parsley family. Carom actually is the pungent and strong-flavored, seed-like fruit of the plant, and frequently is used as part of a spice mixture. It is commonly used in cooking in India, Africa and the Middle East; it has also been used for medicinal purposes.

PAPRIKA is a ground spice made from dried peppers of the Capsicum annum family, including both sweet and hot peppers. It is versatile as it is used both as a seasoning and garnish in food products, and its preparations range from sweet, to hot, to smokey depending on the country of origin, variety of pepper and other factors. The most well-known paprika as originate from Hungary or Spain.

CARAWAY “seeds,” used in food products as whole seeds or ground actually are the dried fruit of the Caraway plant. They are a highly aromatic spice with a distinctive and mild anise and earthy flavor, and frequently are used in savory breads, such as rye, but also are used in flavoring curries, soups, vegetables, meats and sometimes in pickling and brining. The leaves of the caraway plant are used as an herb, both fresh and dried, much like parsley. The root also is consumed as a vegetable, like celery root.

BAY LEAVES are used as a fragrant herb in whole leaf (fresh or dried) or dried, ground form. They are leaves of the bay laurel plant, a slow-growing evergreen shrub of warm climates. Bay leaves generally are used in a dry form and are added to flavor slow-cooking soups, stews and sauces but are removed before consuming the food. This popular herb adds a subtle depth of flavor and brings out the flavors of other herbs and spices.

In the disclosed embodiments the dry weight amount of ingredient(s) sourced from spices and herbs and/or one or more substitutes that have the same or similar flavors, and possibly also the same or similar properties and functionalities as these ingredients as a percent of the umami flavoring replacement system weight, ranges from between 5 to about 10 percent, about 5 and about 6 percent, between about 5 to about 7 percent, between about 5 to about 8 percent, between about 5 and about 10 percent, between about 6 to about 8 percent, between about 7 to about 9 percent, between about 6 to about 9 percent, between about 7 to about 10 percent, between about 6 to about 7 percent, between about 7 to about 8 percent, between about 8 to about 10 percent, between about 9 to about 10 percent.

The single ingredient or combinations of identified fruits, fungi, vegetables (including allium bulbs), aquatic plants, spices and herbs results in a plant-only umami flavoring replacement system that may be us or part in any variety of food products. In some embodiments, the mixtures of the identified, preferred ingredients result in a robust and flavorful umami seasoning system, ideal for replacing artificial, synthetic or highly processed seasonings used in commercially available food products. An intensified umami flavor is achieved through various interactions of compounds within and among the ingredients of the identified categories. Nucleotides interacting with the key amino acids, free amino acids or their di- and tri-peptides identified above in certain ingredients contribute to this robust, umami flavor in individual ingredients such as tomatoes and shitake mushrooms.

In combination with other identified ingredients, however, the umami flavor is maximized through contributions of the multiple ingredients to the mix. Amino acids other that glutamate and aspartate (such as phenylalanine in asparagus, cumin, shitake mushrooms, and tomatoes; and tyrosine in garlic and cumin for example) also are key players in developing the full umami flavor.

Alone or in combination as an umami flavoring replacement system, the previously described ingredients are effective as natural flavoring agents in the umami flavoring replacement system, present in an amount of about 0.5 percent to up to about 15 percent or more of the dry weight of the food product, depending on the type of food product and the strength of flavor desired.

### Synergy Due to the Spice and Herb Source

Cumin—Cumin seeds have glutamic acid, aspartic acid as the umami compounds. Raw seeds don't impart umami flavour much as compared to the toasted ones. The toasted seeds help in leveraging the umami. The other peptide combinations present include the Glutamate-Aspartate (Glu-Asp), Glutamate and Proline (Glu-Pro-Glu), Cysteine and Methionine (Cys-Met) which help in the enhancement of umami flavour.

TABLE 4
Typical ingredients that are commercially availablefor
umami flavoring mix used in the food industry.

| Typical Umami Flavoring | Percent Weight of |
|---|---|
| Mix Components | Umami Flavoring Mix |
| Monosodium glutamate | 5-15 |
| (MSG) | |
| Garlic purée | 5-10 |
| Red wine vinegar | 3-5 |
| Mushroom paste | 5-15 |
| Tomato paste or purée | 10-30 |
| Black olives | 5-10 |
| Beef/chicken stock or paste, | 5-15 |
| and or anchovy paste | |

Table 4 provides an example of typical ingredients found in commercially available (umami) flavoring mixes. The umami flavoring replacement system of the disclosed embodiments can be used in whole or in part to replace the flavoring mix detailed in Table 4.

### Preparation of the Umami Flavoring Replacement System or its Component Categories

In one embodiment, the umami flavoring replacement system, or any of its individual categories, individual ingredients or combinations of ingredients within each category, can be prepared by combining and mixing the dried, powdered ingredients selected from Table 2 in the relative amounts identified as preferred, essential ingredients of the system to be used in a desired food product.

In some embodiments the umami flavoring replacement system may be in the form of a liquid or gel due to the addition of water or other plant-derived liquid. In some embodiments the umami flavoring replacement system is mixed with additional water or plant-derived liquid, then dried and powdered and stored.

In some embodiments the umami flavoring replacement system is prepared in extract or liquid form and freeze dried.

In certain embodiments, the umami flavoring replacement system may be prepared and stored as a liquid or moist form (as in a gel or dough).

In certain other embodiments, the umami flavoring replacement system may be prepared as a liquid, gel or in dried form and then frozen for storage.

In other embodiments, each of the categories of ingredients, individual ingredients, or combinations of ingredients within each of the categories of the umami flavoring replacement system, whether in liquid, gel, dried or other form, are mixed individually directly into and become a part of another food product rather than being combined as the complete replacement system prior to incorporation into another food product.

The addition of a liquid to the replacement system will necessarily modify (increase) relative weight of the replacement system as a component of a food product.

In some embodiments the umami flavoring replacement system is added to a food product before or during heating or cooking, as one would add other seasonings.

In other embodiments, where the food product remains uncooked, the replacement system may be added to the food product in preparation or before consuming; in still other embodiments the replacement system may be used as a seasoning that is sprinkled on a food product prior to consumption, whether the food product is heated/cooked or uncooked/raw.

In some embodiments the umami flavoring replacement system stands alone as a plant-only food product that can be added to one or more ingredients or other food replacement systems to form any type of consumable food product requiring an umami flavoring.

In other embodiments the umami flavoring replacement system is a component of another food product. In certain embodiments the umami flavoring replacement system is a component of a baked good food product, a soup or sauce, or a frozen food product mix (such as a burger, patty or other shape, or mix), which may then be incorporated into other food products.

In still other embodiments the food product is one of several components used to create the final food product. In some embodiments the food product is a stand-alone product. In other embodiments, the ingredients listed in Table 1 may be selected and combined in other relative amounts (a variety of ranges) identified for each of the categories to achieve the required functional and aesthetic features most closely resembling those of conventionally used, commercially available flavorings and additives. In other embodiments, the umami flavoring replacement system may be used as an alternative, natural option to enhance the flavor of pet and other animal feeds.

The combination of categories and ingredients comprising an umami flavoring replacement system for traditional ingredients and additives in commercially available animal- and plant-based products, as well as their physicochemical and Ayurvedic properties are shown in Table 2.

### Table 4: Methods and Preparation of Plant Only Umami Flavoring Replacement System in Food Products.

In an embodiment, the plant only umami flavoring replacement system requires any of its individual categories and blends of ingredients, can be prepared by combining and mixing the dried, powdered ingredients selected from Table 2 in the relative amounts identified as preferred, essential ingredients of the system to be used in a desired food product.

In one embodiment, the plant only umami flavoring replacement system comprises of fruit sources. Yet another embodiment, preparing tamarillos involves washing and drying is done using a food dehydrator. Grinding the dried tamarillos is performed in a blender at 3000 rpm. Storing the powder takes place in a cool, dry place.

In one more embodiment, the plant only umami flavoring replacement system comprises of fungal sources. Yet another embodiment, preparation of mushrooms involves selecting fresh and an undamaged mushroom is followed by washing and cleaning. Dicing and blanching the mushrooms are done in boiling water. Centrifuging the blanched mushrooms removes the moisture, and crushing them into a pulp occurs. Flat layering the pulp in trays and vacuum drying it is done until the moisture falls below 4%. Pulverizing the dried slices is the next step, followed by sieving the powdered mushrooms under 80 meshes to obtain a fine powder with all the flavors intact.

In one more embodiment, the plant only umami flavoring replacement system comprises of vegetable sources. Yet another embodiment, preparation of asparagus stems involves the collecting and cleaning the asparagus stems are done, followed by cutting off the tough ends. Blanching the stems is carried out, and lining them up in a dehydrator is the next step. Drying the stems for 8 to 12 hours at 35° C. occurs. Finally, pulverizing the dried stems into a fine powder takes place.

In one more embodiment, the plant only umami flavoring replacement system comprises of aquatic plant sources. Yet another embodiment, preparation of sugar kelp involves washing the kelp with distilled water and chopping it into small pieces is done. Liquidizing the kelp using an electronic blender follows. Filtering the liquidized kelp using a 0.45 μm membrane filter is performed. Heating the collected filtrate up to 60° C. is done prior to the spraying drying process. Feeding the sea weed filtrate into the main chamber through a peristaltic pump at a rate of 8 mL h-1 is carried out for spray drying. Setting the hot air flow rate into the drying chamber at 40 m3 h-1 and the compressor air pressure at 1.2 MPa at 130, 140, and 150° C. is done. Storing the obtained seaweed powder in a plastic container and storing it in desiccators follow.

In one more embodiment, the plant only umami flavoring replacement system comprises of bulb sources. Yet another embodiment, preparation of onion involves the osmotically dehydration of onion slices by drying the onion slices in a cabinet dryer at 60° C. for 10 hours is performed. Grinding the dried slices in a laboratory powder mill and sieving them with a 30 mesh sieve are done. Storing the sieved samples for up to 6 months in −400 gauge LDPE or 200 gauge HDPE pouches at 7° C. is the final step.

In one more embodiment, the plant only umami flavoring replacement system comprises of spices and herb plant sources. Yet another embodiment, preparation of cumin seeds involves roasting the cumin seeds until they begin to smell earthy, strong, and aromatic is carried out. Grinding the cooled seeds in a spice blender into a fine powder follows. Storing the powder in a dry container is the last step.

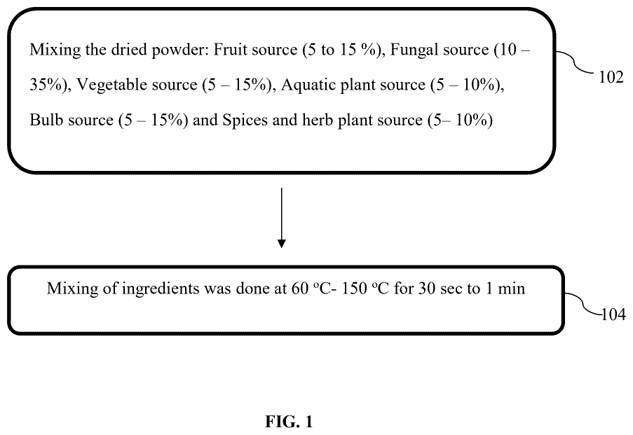

The method and preparation of plant only umami flavoring replacement system in food products is illustrated in the FIG. 1.

The step 102 is the mixing the dried powder: Fruit source (5-15%), Fungal source (10-35%), Vegetable source (5-15%), Aquatic plant source (5-10%), Bulb source (5-15%) and Spices and herb plant source (5-10%).

The 104 says Mixing of ingredients was done for 30 sec to 1 min.

Merely for illustration, only representative number/type of graph, chart, block, and sub-block diagrams were shown. Many environments often contain many more block and sub-block diagrams or systems and sub-systems, both in number and type, depending on the purpose for which the environment is designed.

While specific embodiments of the disclosed embodiments have been shown and described in detail to illustrate the inventive principles, it will be understood that the disclosed embodiments may be embodied otherwise without departing from such principles.

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment” and similar language throughout this specification may, but do not necessarily, all refer to the same embodiment.

It should be understood that the figures and/or screen shots illustrated in the attachments highlighting the functionality and advantages of the disclosed embodiments are presented for example purposes only. The disclosed embodiments are sufficiently flexible and configurable, such that it may be utilized in ways other than that shown in the accompanying FIGURES.

It should be understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A plant-only umami flavoring replacement system for use in food products comprising:
a) 5-15% by weight of a fruit source, b) 10-35% by weight of a fungal source, c) 5-15% by weight of a vegetable source, d) 5-10% by weight of an aquatic plant source, e) 5-15% by weight of a bulb source and f) 5-10% by weight of spice and herb plant source.

2. The plant-only umami flavoring replacement system as claimed in claim 1, wherein the fruit source is selected from tamarillo, strawberries, blueberries, apricots, cherry tomatoes, pineapple, plum, barbados cherry, pomelo, peach or combinations thereof.

3. The plant-only umami flavoring replacement system as claimed in claim 1, wherein the fungal source is selected from shiitake mushroom, maitake mushroom, portobello mushroom, porcini mushrooms, morel mushrooms, enoki mushrooms, oyster mushrooms, chanterelle mushrooms, truffle mushrooms, lion's mane mushroom or combinations thereof.

4. The plant-only umami flavoring replacement system as claimed in claim 1, wherein the vegetable source is selected from asparagus, broccoli, bell peppers, chili peppers, celery, spinach, brussel sprouts, beetroot, cabbage, carrots or combinations thereof.

5. The plant-only umami flavoring replacement system as claimed in claim 1, wherein the aquatic plant source is selected from sugar kelp, konbu, water spinach, watercress, cattail shoots, sea beans, water bamboo, water mimosa, water lily, kangkong, Gracilaria verrucosa, lotus root, water chestnut, red weed or combinations thereof.

6. The plant-only umami flavoring replacement system as claimed in claim 1, wherein the bulb source is selected from onion, garlic, shallot, leek, scallion, fennel bulb, celery bulb, kohlrabi, Jerusalem artichoke, garlic chives, Chinese chives, elephant garlic or combinations thereof.

7. The plant-only umami flavoring replacement system as claimed in claim 1, wherein the spice and herb plant source is selected from cumin, coriander, paprika, caraway, carom bay leaves, ginger root, turmeric root, black peppers, rosemary, peppermint, thyme, Mentha spicata, angelica, caper, marjoram or combinations thereof.

8. The plant-only umami flavoring replacement system as claimed in claim 1, wherein the food products comprise soups, sauces, marinades, meats, vegetables, and snacks.

9. A method for preparing a plant-only umami flavoring replacement system for use in food products, wherein the method comprises:
mixing a) 5-15% by weight of a fruit source, b) 10-35% by weight of a fungal source, c) 5-15% by weight of a vegetable source, d) 5-10% by weight of an aquatic plant source, e) 5-15% by weight of a bulb source and f) 5-10% by weight of spice and herb plant source at a temperature between 60 degrees Celsius and 105 degrees Celsius for about 30 seconds to one minute to form the plant-only umami flavoring replacement system.

10. The method as claimed in claim 9, wherein the fruit source, the fungal source, the vegetable source, the aquatic plant source, the bulb source, and the spice and herb plant source are obtained in powdered form.

11. The method as claimed in claim 9, wherein the fruit source is selected from tamarillo, strawberries, blueberries, apricots, cherry tomatoes, pineapple, plum, barbados cherry, pomelo, peach or combinations thereof.

12. The method as claimed in claim 9, wherein the fungal source is selected from shiitake mushroom, maitake mushroom, portobello mushroom, porcini mushrooms, morel mushrooms, enoki mushrooms, oyster mushrooms, chanterelle mushrooms, truffle mushrooms, lion's mane mushroom or combinations thereof.

13. The method as claimed in claim 9, wherein the vegetable source is selected from asparagus, broccoli, bell peppers, chili peppers, celery, spinach, Brussel sprouts, beetroot, cabbage, carrots or combinations thereof.

14. The method as claimed in claim 9, wherein the aquatic plant source is selected from sugar kelp, kombu, water spinach, watercress, cattail shoots, sea beans, water bamboo, water mimosa, water lily, kangkong, Gracilaria verrucosa, lotus root, water chestnut, red weed or combinations thereof.

15. The method as claimed in claim 9, wherein the bulb source is selected from onion, garlic, shallot, leek, scallion, fennel bulb, celery bulb, kohlrabi, Jerusalem artichoke, garlic chives, Chinese chives, elephant garlic or combinations thereof.

16. The method as claimed in claim 9, wherein the spice and herb plant source is selected from cumin, coriander, paprika, caraway, carom bay leaves, ginger root, turmeric root, black peppers, rosemary, peppermint, thyme, Mentha spicata, angelica, caper, marjoram or combinations thereof.

17. The method as claimed in claim 9, wherein the food products comprise soups, sauces, marinades, meats, vegetables, and snacks.

18. The method as claimed in claim 9, wherein physical characterization data associated with ingredients of the plant-only umami flavoring replacement system comprising the fruit source, the fungal source, the vegetable source, the aquatic plant source, the bulb source, and the spice and herb plant source is stored in a database, wherein a machine learning model determines a unique combination of ingredients based on the physical characterization data to prepare the plant-only umami flavoring replacement system.

19. The method as claimed in claim 18, wherein the physical characterization data of the ingredients comprise functional properties that comprise emulsification properties, stabilization properties, gelling properties, fat-replacement properties, Ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.
